(19) United States
(12) Patent Application Publication
(10) Pub. No.: US 2025/0182159 A1
(43) Pub. Date: Jun. 5, 2025

(54) SYSTEMS AND METHODS FOR DE-TARGETING ELECTRONIC COMMUNICATIONS

(71) Applicant: Coupang Corp., Seoul (KR)

(72) Inventors: Scott Thomas Sheinbaum, San Jose, CA (US); Yan Rui Huang, Sunnyvale, CA (US); Xumeng Lam, Danville, CA (US)

(73) Assignee: Coupang Corp., Seoul (KR)

(21) Appl. No.: 18/964,249

(22) Filed: Nov. 29, 2024

Related U.S. Application Data
(63) Continuation-in-part of application No. 18/399,147, filed on Dec. 28, 2023.
(60) Provisional application No. 63/604,963, filed on Dec. 1, 2023.

(51) Int. Cl. G06Q 30/0251; G06Q 30/0202

(52) U.S. Cl. CPC G06Q 30/0255; G06Q 30/0202

(57) ABSTRACT

A computer system for targeting electronic communications, the system may determine a response to electronic communications by receiving interaction data indicating interactions with electronic communications, receiving purchase data indicating the user's purchases, determining a metric representing the user's response based on the received interaction data and the received purchase data, and comparing the metric to a threshold. The system may generate instructions for users with a determined positive response to receive electronic communications, for a test group of users to not receive electronic communications, and for a control group of users to receive electronic communications. The system may repeatedly re-assign user identifiers associated with the users in the test group to the control group upon determining the user's purchasing behavior has declined relative to a purchasing behavior of the control group.

### CROSS-REFERENCE TO RELATED APPLICATIONS

This application claims priority to U.S. Provisional Application No. 63/604,963, titled “Direct Advertising Detargeting,” filed Dec. 1, 2023 (Attorney Docket No. 14904.6009-00000) and to U.S. application Ser. No. 18/399,147, titled “Systems and Methods for Tracked Electronic Communications Apportionment”, filed Dec. 28, 2023 (Attorney Docket No. 14904.0293-00000). The entire contents of the aforementioned application are incorporated by reference herein for all purposes.

### TECHNICAL FIELD

The present disclosure generally relates to computerized systems and methods for targeted electronic advertising. In particular, embodiments of the present disclosure relate to inventive and unconventional systems to identify consumers to receive electronic advertisements, identify consumers to not receive electronic advertisements, and generate instructions so that electronic advertisements can be sent to the appropriate consumers.

### BACKGROUND

Different consumers react to electronic advertisements in different manners. Some consumers have a positive reaction to electronic advertisements and are more likely to make a purchase after interacting with an advertisement. Some consumers have a neutral reaction to electronic advertisements and their likelihood of making a purchase is not impacted by interacting with an advertisement. Finally, some consumers have a negative reaction to electronic advertisements and are less likely to make a purchase after interacting with an advertisement.

Sending electronic advertisements to consumers who have a negative or a neutral reaction to such electronic advertisements can be wasteful of technical resources. For example, processing data required to transmit electronic advertisements can require processing millions of multi-dimensional data sets to effectively target consumers based on interests, past purchases, and other data. Including consumers who have a negative or a neutral reaction to advertisements requires unnecessary data processing steps and wastes computing resources. Sending advertisements to consumers that will not have a positive reaction can also be wasteful of financial resources.

Additionally, consumers' reactions to electronic advertising are not static. Instead, a consumer's reaction to electronic advertising may change based on an advertising channel they are interacting on. For example, a consumer may have a positive response to electronic advertisements received via email and a negative response to electronic advertisements received on a mobile device (e.g., via a push notification). Existing systems do not consider this variable and therefore waste resources by sending advertising through electronic avenues that have no impact or a negative impact on consumers' purchasing behavior.

Similarly, a consumer's reaction to advertising may change based on the device they are using, the type of advertising they are receiving, changes to their characteristics (e.g., location, age etc.), and/or simply with the passage of time. Existing systems are static and not able to evaluate the impact of advertising in consideration of these variables, thereby wasting resources (financial and otherwise) by not accurately determine consumers to remove from advertising.

Therefore, there is a need for improved methods and systems for determining how a consumer reacts to advertisements and tracking changes to their reaction in consideration of different variables (e.g., channels, devices, timeframes etc.). Further, there is a need to automatically remove consumers with a neutral and/or negative reaction to advertisements from receiving advertising content. Automatically removing consumers with a neutral and/or negative reaction to advertisements will save on advertising costs, avoid wasted computing resources, and avoid detrimental consumer purchasing behavior.

In addition to the plain technical benefits that one of ordinary skill would understand are associated with the embodiments of the present disclosure (e.g., by saving on the use of storage, processing, and network transmission resources), initial testing of embodiments of the present disclosure demonstrate the possibility of saving upwards of $20 million USD per year in advertising costs.

### SUMMARY

One aspect of the present disclosure is directed to a computer-implemented system for targeting electronic communications comprising a memory storing instructions, and at least one processor configured to execute instructions to: determine a response to electronic communications for each user of a group of users, by: receiving interaction data indicating interactions with a first set of electronic communications via a first user device, associated with the user, in a first set period of time, receiving purchase data indicating the user's purchases in the first set period of time, determining a metric representing the user's response to the first set of electronic communications based on the received interaction data and the received purchase data, and comparing the metric to a threshold to determine a response associated with the user regarding electronic communications. The at least one processor is further configured to generate first instructions for users with a determined positive response to electronic communications to receive electronic communications, generate second instructions for a test group of users with a determined negative response to not receive electronic communications, generate third instructions for a control group of users with a determined negative response to receive electronic communications, and send electronic communications by executing the first and third instructions. The at least one processor is further configured to repeatedly re-assign user identifiers associated with the users in the test group to the control group after each increment of a second set period of time, by: comparing purchasing behavior of each user in the test group to a purchasing behavior of the control group, and removing user identifiers of users in the test group and assigning them to the control group to receive electronic communications when the comparison indicates the user's purchasing behavior has declined relative to the purchasing behavior of the control group.

Another aspect of the present disclosure is directed to a computer-implemented method for targeting electronic communications, the method comprising: receiving interaction data indicating interactions with a first set of electronic communications via a first user device, associated with the user, in a first set period of time, receiving purchase data indicating the user's purchases in the first set period of time, determining a metric representing the user's response to the first set of electronic communications based on the received interaction data and the received purchase data, and comparing the metric to a threshold to determine a response associated with the user regarding electronic communications. The method further comprising generating first instructions for users with a determined positive response to electronic communications to receive electronic communications, generating second instructions for a test group of users with a determined negative response to not receive electronic communications, generating third instructions for a control group of users with a determined negative response to receive electronic communications, and sending electronic communications by executing the first and third instructions. The method further comprising repeatedly re-assigning user identifiers associated with the users in the test group to the control group after each increment of a second set period of time, by: comparing purchasing behavior of each user in the test group to a purchasing behavior of the control group, and removing user identifiers of users in the test group and assigning them to the control group to receive electronic communications when the comparison indicates the user's purchasing behavior has declined relative to the purchasing behavior of the control group.

Yet another aspect of the present disclosure is directed to a computer-implemented system for targeting electronic communications comprising a memory storing instructions, and at least one processor configured to execute instructions to: determine a response to electronic communications for each user of a group of users, by: receiving click data indicating interactions with a first set of electronic communications via a first user device, associated with the user, in a first set period of time, receiving data from the user device indicating at least one characteristic of the user, utilizing a model to correlate a purchasing tendency with the at least one characteristic and the received interaction data, wherein the model comprises at least one of a linear regression model or neural network, receiving a user purchase amount in the first set period of time, determining a portion of the user purchase amount allocated the first set of electronic communications using the model, and comparing the portion of user purchase amount allocated to the first set of electronic communications to a threshold to determine a response associated with the user regarding electronic communications. The at least one processor further configured to: generate first instructions for users with a determined positive response to electronic communications to receive electronic communications, generate second instructions for a test group of users with a determined negative response to not receive electronic communications, generate third instructions for a control group of users with a determined negative response to receive electronic communications, and send electronic communications by executing the first and third instructions. The at least one processor further configured to: repeatedly re-assign user identifiers associated with the users in the test group to the control group after each increment of a second set period of time, by: comparing purchasing behavior of each user in the test group to a purchasing behavior of the control group, and removing user identifiers of users in the test group and assigning them to the control group to receive electronic communications when the comparison indicates the user's purchasing behavior has declined relative to the purchasing behavior of the control group.

### BRIEF DESCRIPTION OF THE DRAWINGS

FIG. 1 is a schematic block diagram illustrating an embodiment of a network comprising computerized systems for evaluating effects of electronic advertising, consistent with the disclosed embodiments.

FIG. 2A depicts a table of tracking user interactions across advertising channels and/or publishers, consistent with the disclosed embodiments.

FIG. 2A depicts a table of weighting user interactions across advertising channels and/or publishers, consistent with the disclosed embodiments.

FIG. 3 illustrates a flow chart for apportioning a transaction, consistent with the disclosed embodiments.

FIG. 4 illustrates a flow chart for electronic advertising de-targeting, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims. Embodiments of the present disclosure are directed to systems and methods configured for targeted advertising.

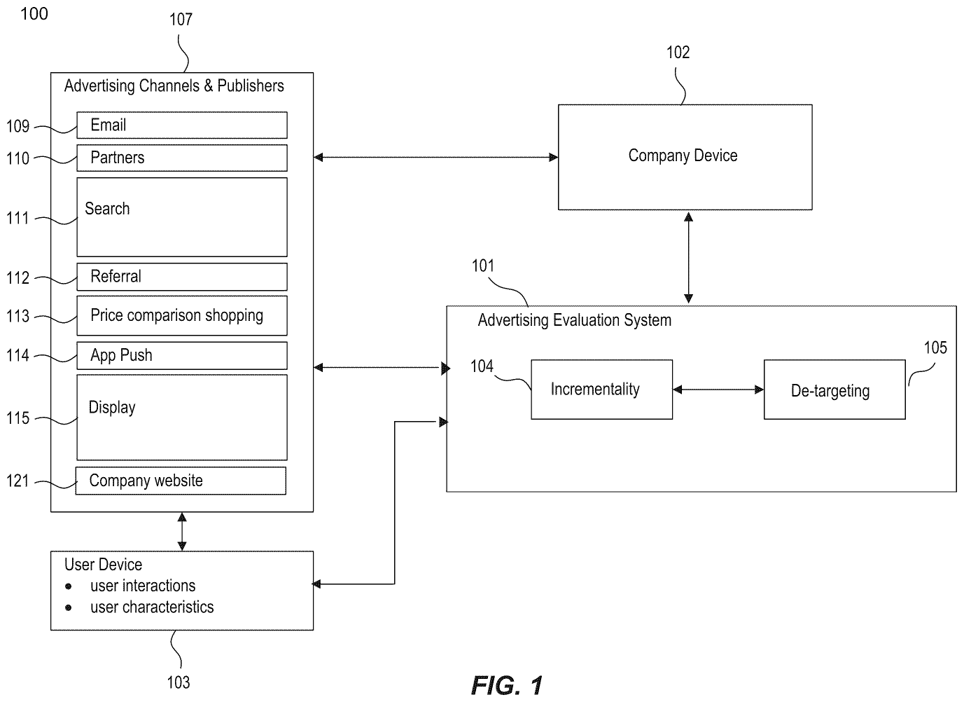

Referring to FIG. 1, illustrating an embodiment of a network comprising computerized systems for evaluating effects of electronic advertising, consistent with the disclosed embodiments. As illustrated in FIG. 1, system 100 may include a variety of systems, each of which may be connected to one another via one or more wireless networks. The systems may also be connected to one another via a direct connection, for example, using a cable. The depicted systems include Advertising Channels and Publisher Systems 107, Company Device 102, User Device 103, and Advertising Evaluation System 101. In some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

Advertising Channels and Publisher Systems 107 may include one or more advertising channels and publishers that publish advertisements on a platform. In some embodiments, an advertising channel may refer to an avenue of providing electronic advertisements. For example, a channel may include a group of publishers that distribute advertisements in a similar manner, such as a group of publishers that deliver advertisements in response to search terms. As further described below, a company may allocate one, two, three, or any number of publishers to a channel if they desire to track interactions made on platforms of those publishers together. A publisher may include one or more systems that publish advertisements to one or more platforms. In some embodiments a publisher may publish advertisements on a single platform, while in other embodiments a publisher may publish advertisements on multiple platforms. A platform may include a digital interface and associated software and coding to display advertisements and receive user interactions. Advertisements may include at least one of: content related to a company product, content related to a company service, content related to an event, or any other communication on a platform.

In some embodiments, an Email Channel 109 may comprise one or more systems that display email advertisements to users. Email advertisements may refer to advertisements received in the form of an email. Publishers within the Email Channel 109 may provide advertisements for one or more email platforms to display.

In some embodiments, Partners Channel 110 may comprise one or more systems that are managed by a different company that display advertisements to users. In some embodiments, the different company may include a company that sells products from multiple companies, including products of the company whose advertisements are to be tracked. Publishers within Partners Channel 110 may provide advertisements for one or more partner platforms to display.

In some embodiments, Search Channel 111 may comprise one or more systems that display advertisements to users on search interfaces. The advertisements may be displayed in response to one or more keywords being typed by the user. Publishers within Search Channel 110 may provide advertisements for one or more search platforms to display. For example, a Publisher may include a search engine and/or other computer systems that provide information to one or more search platforms (e.g. search display interfaces). A search platform may include an interface that allows users to search for content by typing words. For example, a user may be provided dog websites and or images upon typing “dog”.

As further detailed below, company device 102 may specify one or more keywords that, if typed by a user, will cause the search platform to display an advertisement. A publisher and/or platform of the search channel may store keywords and include instructions for providing advertisements in response to the keywords. The company device may change the specified keywords automatically or through user input (e.g. next set of keywords is automatically pulled from a database of keywords).

In some embodiments, Referral Channel 112 may comprise one or more systems that display advertisements to one or more users based on another user sharing the advertising content with them. Publishers within Referral Channel 112 may provide advertisements for one or more platforms to display.

In some embodiments, Price Comparison Shopping Channel 113 may comprise one or more systems that display advertisements to users who are interacting with a price comparison platform. A price comparison platform may include an interface that allows a user to compare products and/or associated product pricing from different companies. Publishers within Price Comparison Shopping Channel 113 may provide advertisements for one or more Price Comparison Shopping platforms to display.

In some embodiments, App Push Channel 114 may comprise one or more systems that display advertisements to users through one or more applications. In some embodiments, one or more of the applications may include an application that is run by a company providing the advertised products. For example, the application may allow for a user to view advertisements, view deals, view available products, add products to a cart, and/or make a product purchase. Publishers within the App Push Channel 114 may provide advertisements for the application platforms to display.

In some embodiments, Display Channel 115 may comprise one or more systems that display advertisements to users on one or more platforms that are accessible by multiple people. For example, Display Channel 115, may include publishers that provide information to social media platforms.

In some embodiments, Company Website 121 may comprise a website managed by Company Device 102 that allows a user to view and purchase products. In some embodiments, Company Website 121 may display advertisements to users, while in other embodiments the Company Website 121 may simply allow for product selection and purchasing. Company Website 121 may allow users to perform one or more product transactions, such as clicking on product information (e.g. to see more details), adding a product to a cart, inputting payment information for a product, and/or purchasing a product. In some embodiments, completing a transaction may include performing at least one of the product transactions.

While the above advertising channels are shown as an example, any grouping of advertising platforms into a single channel is possible. For example, in some embodiments, the one or more platforms associated with the Display Channel 115 and the one or more platforms associated with the Price Comparison Shopping Channel 113 may be assigned to a single channel (e.g. through Company Device 102). Similarly, the one or more systems associated with Email Advertising Channel 109 and App Push Advertising Channel 114 may instead comprise a single channel. The grouping of platforms into separate channels may vary based on the tracking needs of a company selling an advertised product. For example, certain platforms may be included in a single channel by one company, but may be included in different channels by another company. Further, in some embodiments, the grouping of platforms into advertising channels is flexible. As further described below, a company may assign user interactions received by certain platforms to a desired advertising channel.

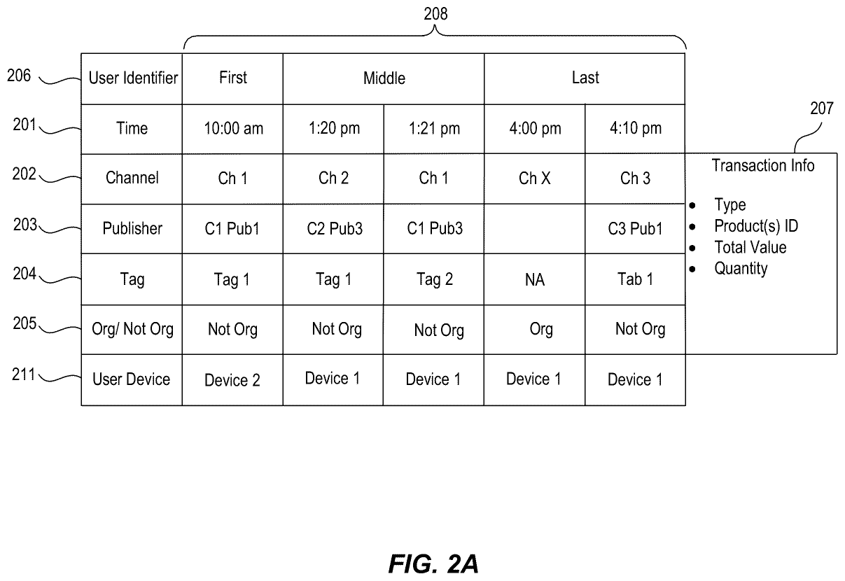

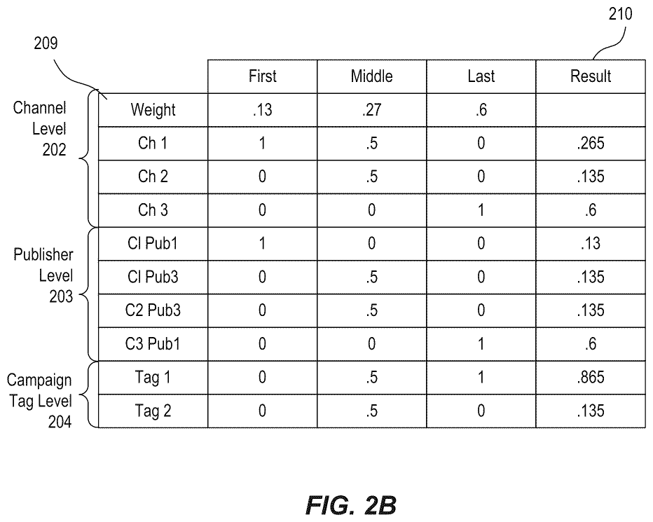

The grouping of publishers into separate channels may vary based on the tracking needs of the company selling an advertised product. For example, one company may consider certain publishers as part of a single channel, but another company may consider the publishers in separate channels. Further, in some embodiments, the grouping of publishers into advertising channels is flexible and may be changed by a company. As described below with reference to FIG. 2a, grouping publishers into a same channel may include assigning them the same channel identifier for tracking.

Advertising Channels and Publishers 107 are schematically shown grouped together. However, in some embodiments, the advertising channels and/or publishers may include one or more separate systems that communicate with other channel(s), other publisher(s), Company Device 102, User Device 103, Advertising Evaluation System 101, Incrementality System 104, and/or De-targeting System 105.

In some embodiments, the Advertising Channels and Publishers 107 may track characteristic information about a user who interacts on the platforms. In some embodiments, the publishers track characteristic information about a user who interacts on the platform. For example, a publisher (e.g. a social media publisher) may store information on user characteristics. A user (e.g. through one or more devices) may select different characteristics that they identify with and the user characteristic information may be based on these selections. For example, a user may make selections on the platform indicating their gender, age, location, company membership status (e.g. on Company Website 121), content they “liked” or otherwise engaged/interacted with, and/or events they have attended. In some embodiments, Advertising Channels and Publishers 107 may derive characteristic information based on the user selections.

Further, one or more publisher systems may derive user characteristic information from user activity on one or more platforms. In some embodiments, a publisher may track user interests by installing an impression tracker on a platform. For example, the impression tracker may include a transparent image associated with displayed content of a certain interest. Each time the displayed content and associated transparent image is loaded for display (e.g. on a browser), the system counts an impression. In some embodiments, the publisher may use a different means of impression tracking. A publisher may additionally or alternatively track user characteristic information by installing a click tracker on the platform. The click tracker may include installing cookies associated with displayed content of a certain interest and/or a click map that tracks user interactions. Each publisher may include specific software and/or coding to track user selections, user impressions, and/or user clicks.

In some embodiments, all of the user characteristic information received for the user is provided to the Advertising Evaluation System 101. In some embodiments, Advertising Evaluation System 101 may provide a portion of the user characteristic information. For example, the portion of user characteristic information sent may be based on user privacy selections on the platform and/or privacy regulations.

In some embodiments, the Advertising Channels and Publishers 107 may track user interactions with advertisements displayed on a platform. User interactions may include one or more of: clicks on the advertisement, swipes on the advertisement, impression on the advertisement, mouse hovering over the advertisement, additions to a cart on a company website, or removals from a cart on a company website. In some embodiments, the publishers track user interactions with advertisements displayed on the platform. A publisher may track user interactions with an advertisement by installing an impression tracker on the platform. The impression tracker may include a transparent image associated with the advertisement. Each time the advertisement is loaded for display (e.g. on a browser), the system counts an impression. Further, a publisher may code the impression tracker to provide a channel tag identifier, a publisher tag identifier, and/or an advertisement campaign identifier to the Advertising Evaluation System 101 upon detecting an impression.

Systems (e.g., those owned/operated by a publisher) may additionally or alternatively track user interactions with an advertisement by installing a click tracker on the platform. The click tracker may include cookies installed on the platform associated with the advertisement and/or a click map that tracks user interactions. Further, a publisher may code the click tracker to provide a channel tag identifier, publisher tag identifier, and/or an advertisement campaign identifier to the Advertising Evaluation System 101 upon detecting a click. In some embodiments, Company Website 121 may further track product transactions based on user selections and/or click tracking.

A publisher may additionally or alternatively track user interactions with an advertisement by installing a swipe tracker. For example, a publisher may code a platform to provide a channel tag identifier, publisher tag identifier, and/or an advertisement campaign identifier to the Advertising Evaluation System 101 upon detecting a swipe. A swipe may include the user moving an advertisement in any direction.

A publisher may additionally or alternatively track user interactions with an advertisement by installing a hover tracker and/or a map to track the hovering of a mouse. For example, a publisher may code a platform to provide a channel tag identifier, publisher tag identifier, and/or an advertisement campaign identifier to the Advertising Evaluation System 101 upon detecting hovering.

Advertising Channels and Publishers 107 may communicate directly and/or indirectly, through wired or wireless communication, with User Device 103, Company Device 102, and/or Advertising Evaluation System 101. A user on User Device 103 may launch one or more platforms from Advertising Channels and Publishers 107 on a device and perform the selections and/or interactions described above. Company Device 102 may communicate with Advertising Channels and Publishers 107 to make changes to advertisements for company products. Advertising Evaluation System 101 may communicate with Advertising Channels and Publishers 107 to receive information on user characteristics and/or user interactions.

Further, Advertising Channels and Publishers 107 may include one or more computer systems. For example, a publisher system may include at least one processor (such as an x86 or x64 compatible processor) and at least one memory storage device (such as flash memory). For example, publisher system may store list(s) tracking user characteristic information and/or user interactions in one or more databases, data stores, flat files, or other storage modalities on one or more memory storage devices. Further, a publisher system may communicate with additional systems, platforms, databases, and/or cloud storage centers (not shown) to store user characteristic information, receive user characteristic information, and/or to perform any function of the disclosed embodiments.

Company Device 102 may include one or more devices and/or systems that allow for a company to sell products, track advertising, and/or make changes to product advertising. Company device 102 may be implemented as a computer, laptop, tablet, mobile phone, smart phone, PDA, or any other computerized system that allows for a company employee to communicate with Advertising Channels and Publishers 107 and Advertising Evaluation System 101. Company Device 102 may communicate directly and/or indirectly, through wired or wireless communication, with Advertising Channels and Publishers 107 and/or Advertising Evaluation System 101. Company Device 102 may communicate with Advertising Channels and Publishers 107 to set advertising information. For example, Company Device 102 may provide advertising content to one or more platforms of Advertising Channels and Publishers 107. Advertising content may include product pictures, descriptions, sale details, code for content display, cookie tracker for the advertisement, and/or impression pixels for the advertisement. Company Device 102 may provide parameters for display of the advertising content to one or more platforms of Advertising Channels and Publishers 107.

Parameters for display of advertising content may include display location on a platform, time of display, timeframe for display, search keywords that trigger the display, cost allocated for display, number of users to receive the advertisement, type of users to receive the advertisement, identifiers of users to receive advertisements, identifiers of devices to receive advertisements, and/or conditions under which users receive advertisements. In some embodiments, Company Device 102 may provide information on what users may receive advertising and/or under what conditions a user receives advertising (e.g., based on information from Advertising Evaluation System 101 and/or De-targeting System 105). For example, Company Device 102 may provide user identifiers (e.g., a username, phone number, email address, identifier generated by one or more platforms, and/or other identifier that identifies a user across one or more devices) and/or an identifier of a devices (e.g., User Device 103) to receive advertising and identifiers indicating the type of advertising to receive (e.g., corresponding to one or more advertisement campaign identifiers, as described below). Company Device 102 may send this information to one or more systems of Advertising Channels and Publishers 107 in one or more formats (e.g. lists, searchable tables etc.) and/or data types (csv, json, etc.). In some embodiments, Company Device 102 may send this information in the form of emails, push notifications, SMS notifications, and/or MMS notifications. Company Device 102 may additionally or alternatively post this information to a separate system, database, and/or cloud storage center that is accessible to one or more systems of Advertising Channels and Publishers 107.

In some embodiments, Company Device 102 may create and/or update a searchable table to indicate, for each advertisement and/or advertising campaign, identifiers of users to receive the advertisement, identifiers of user devices to receive the advertisements, and/or identifiers of channels, publishers, and/or platforms on which each user will receive the advertisement(s). Company Device 102 may automatically provide the information on what users (e.g., user or device identifiers) may receive advertising and/or under what conditions (e.g., advertising campaign(s), device(s), channel(s), publisher(s), and/or platform(s)) a user receives advertising based on the searchable table and/or may otherwise make the searchable table accessible to to one or more systems of Advertising Channels and Publishers 107 (e.g., by posting to an accessible system, database, and/or cloud storage center).

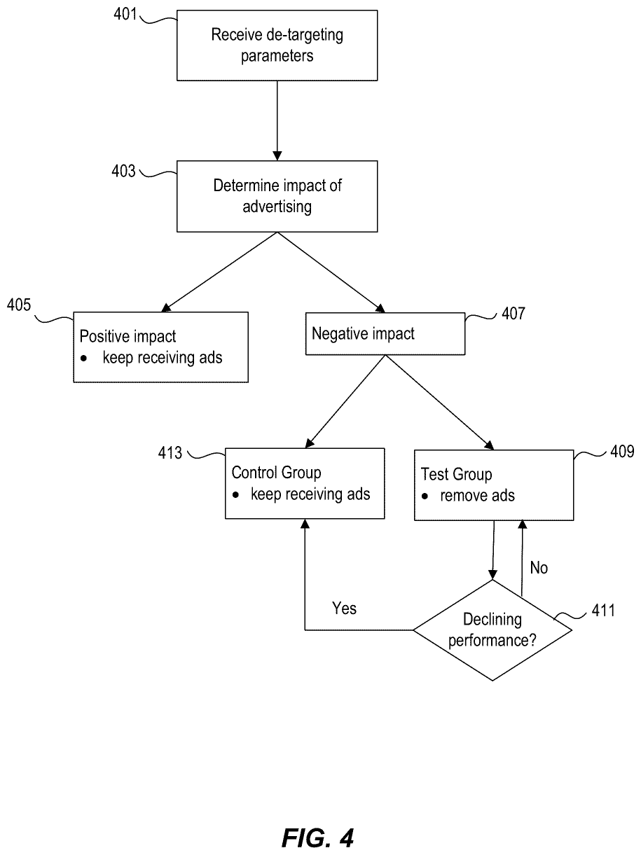

In some embodiments, Company Device 102 may perform these updates and/or provide this information on what users may receive advertising and/or under what conditions each user receives advertising based on information received from Advertising Evaluation System 101 and/or De-targeting System 105. For example, Advertising Evaluation System 101 and/or De-targeting System 105 may perform the de-targeting process as described below with reference to FIG. 4 and automatically output these updates and/or provide this information to Company Device 102, based on the results of the process.

Company Device 102 may provide other information for tracking the displayed advertised content to one or more platforms of Advertising Channels and Publishers 107. Tracking information may include a channel tag identifier, publisher tag identifier, device identifier, and/or an advertisement campaign identifier. In some embodiments, this information may be provided separately from the advertisement content, while in other embodiments this information is embedded in code associated with the advertised content.

Company Device 102 may update Company Website 121 to include new products, change product descriptions, change product images, change product pricing, and/or change product advertisements. Company Device 102 may communicate with Advertising Evaluation System 101 and/or Incrementality System 104 to track advertising. For example, Company Device 102 may receive evaluation information and make changes to advertisement display parameters. In some embodiments, Advertising Evaluation System 101 may be part of Company Device 102, while in other embodiments they may be separate.

Company Device 102 may include one or more computer systems, including at least one processor (such as an x86 or x64 compatible processor) and at least one memory storage device (such as flash memory). For example, Company Device 102 may store advertising parameters associated with one or more platforms, available products, and/or user information in one or more databases, data stores, flat files, or other storage modalities on one or more memory storage devices. Further, Company Device 102 may communicate with additional systems, platforms, databases, and/or cloud storage centers (not shown) to store advertising parameters, receive advertising parameters, and/or to perform any function of the disclosed embodiments.

Company Device 102 may include one or more user input device(s) (e.g., a graphical user interface, keyboard, button(s) etc.) that allows a user of a company to set and/or modify parameters for the display of advertising content, tracking information, and/or for de-targeting evaluation (e.g., threshold(s), allocation of user(s) and/or timeframe(s) used in the de-targeting process described in FIG. 4, below). In some embodiments, Company Device 102 may provide user interface element(s) (e.g., button(s), slider(s), and/or typing box(es)) that allow a user of a company to initiate a de-targeting evaluation. In some embodiments, Company Device 102 may provide user interface element(s) that allow a user of a company to set timeframe(s) for performing de-targeting evaluation and/or adding users for re-targeting, as further described below with reference to FIG. 4. In some embodiments, Company Device 102 may provide user interface element(s) that allow a user of a company to set one or more relevant channels, publishers, advertisements, advertising campaigns, and/or user devices upon which to perform the de-targeting evaluation. Company Device 102 may provide user interface element(s) that allow a user of a company to set proportions and/or a number of users to be added to a control group and test group in the de-targeting evaluation process. Company Device 102 may provide user interface element(s) that allow a user of a company to establish a threshold performance (e.g., a threshold incremental return on advertising spending (iROAS)), below which a user may be added to a re-target group and begin receiving electronic advertisements.

Company Device 102 may include one or more display devices (e.g., LCD display screen, an LED display screen, a touchscreen display, a projected display, a holographic display, and/or an augmented reality display (such as a heads-up display device or a head-mounted device)) to provide information on the status of de-targeting. For example, based on information received from De-targeting System 105, Company Device 102 may display a dashboard of various metrics. In some embodiments, metrics may include a number and/or proportion of one or more of: users receiving advertisements, users identified as having a negative response to advertising, users identified as having a positive response to advertising, users in a test group, users in a control group, users removed from test group, users remaining in test group, and/or any other metric that might be used to understand the impacts of the targeted advertising process. In some embodiments, metrics may include an overall gross merchandise value (GMV), profit, revenue, iROAS, ROAS, resource usage (e.g., storage, processing, and/or network transmission resources), and/or advertising costs before, during, and after performing de-targeting. In some embodiments, the above metrics may be displayed in numeric form (e.g., as a number or percent) and/or may be graphically represented (e.g., via a pie chart, bar chart, line graph etc.).

Advertising Evaluation System 101 may include one or more systems that allow for a company to evaluate advertising effectiveness and make changes to advertising. As further described below, advertising evaluation can be specific to a user, channel, publisher, device, and/or advertisement content. Advertising Evaluation System 101 may include an Incrementality System 104 and De-targeting System 105. Incrementality System 104 may include one or more systems that allow for a user transaction to be apportioned to one or more channels and/or publishers. De-targeting System 102 may include one or more systems that allow for users to be added and removed from receiving electronic advertisements under certain conditions.

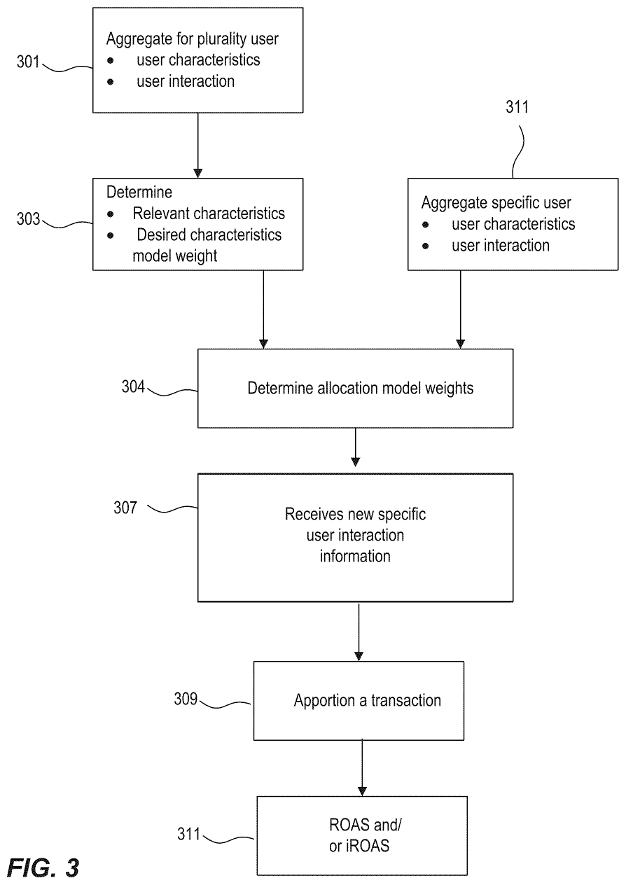

Incrementality System 104 may store one or models for determining the weight that user characteristics has on probability to complete a transaction (e.g. including, make a purchase, add an item to a cart, etc.). The Incrementality System 104 may store one or more models for determining the weight that an advertising channel and/or a publisher has on a probability to complete a transaction. As further described below with reference to FIG. 3, these models may include one or more linear regression models, neural networks, and/or any other model that can weigh the effect of certain attributes.

Incrementality System 104 may store user characteristic information and user interaction information (e.g. based on information received from User Device 103 and/or one or more platforms of Advertising Channels and Publishers 107) for each user. Incrementality System 104 may associate user characteristic information with a user identifier and/or a device identifier. User interaction information may include clicks, impressions, and/or user transaction information for each user (e.g. completed product purchase, product added to cart etc.), based on information received from User Device 103 and/or one or more platforms of Advertising Channels and Publishers 107. Incrementality System 104 may associate the user transaction information with a user identifier, and/or other user interaction information in a time period leading up to the transaction, as further detailed below with reference to FIG. 2. In some embodiments, a Company Device 102 may set the time period for user interactions to be associated with a user transaction.

Incrementality System 104 may store weight information for one or more advertising channels and/or publishers based on the impact advertisements on the advertising channels and/or publishers has on a user's probability to complete a transaction (e.g., make a purchase, add an item to a cart etc.). Incrementality System 104 may store the user characteristic information, user interaction information, and/or user weight information in one or more formats (e.g. searchable tables) and/or data types (csv, json, etc.) that allow for access by the Advertising Evaluation System 101 to perform one or more evaluation processes. Further, the Incrementality System 104 may store instructions for performing one or more evaluation processes. For example, Incrementality System 104 may store instructions for performing one or more of the processes detailed below with reference to FIG. 3. Incrementality System 104 and/or another system may monitor the effectiveness of advertising channels and/or publishers and to make changes to the models and/or weights used by Incrementality System 104 to apportion a purchase.

De-targeting System 105 may evaluate which users receive which advertisements and under what conditions and generate instructions accordingly. In some embodiments, De-targeting System 105 may store a list of users to not receive advertisements and/or a list of users to receive advertisements. For example, De-targeting System 105 may store such list(s) in one or more databases, data stores, flat files, or other storage modalities on one or more memory storage devices (e.g., a flash memory). In some embodiments, these lists of users are stored elsewhere (not shown) and De-targeting System 105 provides and/or updates which users (e.g., user identifiers and/or user device identifiers) should be in each group. In some embodiments, De-targeting system 105 may communicate with additional systems, platforms, databases, and/or cloud storage centers (not shown) to store user information, receive user information, and/or to perform any function of the disclosed embodiments.

In some embodiments, De-targeting System 105 may add to and remove data from a list of users to not receive advertisements and/or a list of users to receive advertisements. In some embodiments, as described above, De-targeting System 105 may indicate to Company Device 102 users (e.g., user identifiers and/or user device identifiers) to be receive electronic advertisements. For example, Company Device 102 may initiate de-targeting evaluation (e.g., process of FIG. 4) and De-targeting System 105 may provide results indicating users to receive electronic advertising and/or not receive electronic advertising. In some embodiments, these results may be provided on a continuous basis, while in other embodiments they may be provided at a set time interval (e.g., as established by Company Device 102). In some embodiments, De-targeting System 105 may update a searchable table to indicate for each advertisement and/or advertising campaign, identifier(s) of users to receive the advertisement, identifier(s) of user device(s) to receive the advertisement(s), and identifier(s) of channels, publisher(s), and/or platform(s) on which each user will receive the advertisement(s).

In some embodiments, De-targeting System 105 (and/or Company Device 102) may generate and send notifications in the form of emails, push notifications, SMS notifications, and/or MMS notifications (e.g., to Company Device 102 and/or one or more systems of Advertising Channels and Publisher Systems 107) and/or may display metrics of the de-targeting process. In some embodiments, these metrics may include number and/or proportion of one or more of: users receiving advertisements, users identified as having a negative response to advertising, users identified as having a positive response to advertising, users in a test group, users in a control group, users removed from test group, users remaining in test group, and/or any other metric that might be used to understand the impacts of the targeted advertising process. In some embodiments, these notifications may include general information (e.g., “30-45 year old male from Seoul metropolitan area”) or specific information (“Hong Gil Dong, age 31, postal code 05510”) regarding users added to a test group or removed from a test group.

Advertising Evaluation System 101 may communicate directly and/or indirectly, through wired or wireless communication, with User Device 103, Company Device 102, and/or Advertising Channels and Publishers 107. In some embodiments, Advertising Evaluation System 101 may communicate with User Device 103 to receive user interactions. For example, one or more platforms of Advertising Channels and Publishers 107 may install click or impression trackers on their platform that are coded in a manner that allow user interaction information (e.g. impressions, clicks, channel identifier, publisher identifier, advertisement campaign identifier, user identifier, user device identifier, transaction information) to be sent directly to Advertising Evaluation System 101. In some embodiments, Advertising Evaluation System 101 may communicate with User Device 103 to receive user characteristic information. For example, one or more platforms of Advertising Channels and Publishers 107 may code their interface in a manner that allows for user characteristic information to be directly sent to Advertising Evaluation System 101.

In some embodiments, Advertising Evaluation System 101 may communicate with Company Device 102 to provide evaluation information and/or set advertisement parameters. In some embodiments, Advertising Evaluation System 101 may be part of Company Device 102. In some embodiments, Advertising Evaluation System 101 may communicate with Advertising Channels and Publishers 107. For example, instead of directly collecting user characteristic information and/or user interactions from User Device 103, Advertising Evaluation System 101 may receive that information through communications with one or more platforms of Advertising Channels and Publishers 107.

Advertising Evaluation System 101, including Incrementality System 104 and De-targeting System 105, may include one or more computer systems, including at least one processor (such as an x86 or x64 compatible processor) and at least one memory storage device (such as flash memory). Further, Advertising Evaluation System 101, including Incrementality System 104 and De-targeting System 105, may communicate with additional systems, platforms, databases, and/or cloud storage centers (not shown) to store threshold information, parameter information, user characteristic information, user transaction information, weights, and/or to perform any function of the disclosed embodiments.

User Device 103 may include one or more computers, laptops, tablets, mobile phones, smart phones, PDAs, or any other computerized system that allows for a consumer to interact with advertising content. User Devices 103 may receive and display advertisements to a user (e.g. by launching a platform from Advertising Channels and Publishers 107). In some embodiments, a user may be a customer of a company associated with Company Device 102, while in other embodiments the user may not be a customer of the company. In some embodiments, User Device 103 may track user characteristic information and/or user interactions and may provide that information to Advertising Channels and Publishers 107 and/or to Advertising Evaluation System 101. For example, a User Device 103 may track characteristic information about a user based on the user selecting different characteristics that they identify with. For example, a user may make selections on the platform indicating their gender, age, location, company membership status of a company associated with Company Device 102, selections on product interest surveys, and/or events the user selected as having attended. Further, Advertising Evaluation System 101 may derive user characteristic information from user activity on the User Device 103. For example, a User Device 103 may include one or more applications for collecting and/or distributing user characteristic information based on information received from one or more platforms that include trackers. Similarly, User Device 103 may include one or more applications for collecting and/or distributing user interaction information based on information received from one or more platforms that include trackers. The trackers may include impression or click trackers, as described above.

User Device 103 may communicate directly and/or indirectly, through wired or wireless communication, with Advertising Evaluation System 101 and/or Advertising Channels and Publishers 107. In some embodiments, User Device 103 may send user characteristic information and/or user interaction information to Advertising Channels and Publishers 107 and/or Advertising Evaluation System 101. In some embodiments, all the user characteristic information received by User Device 103 is provided to Advertising Channels and Publishers 107 and/or Advertising Evaluation System 101. In some embodiments, User Device 103 may provide a portion of the user characteristic information to Advertising Channels and Publishers 107 and/or Advertising Evaluation System 101. For example, the portion of user characteristic information sent by User Device 103 may be based on user privacy selections on the platform and/or privacy regulations.

Further, User Device 103 may allow for a consumer to perform a transaction (e.g. purchase a product). The User Device 103 may display a webpage including details on the product and/or options for purchasing the product (e.g. webpage from Company Website 121). For example, User Device 103 may allow a user to click on or otherwise interact with a user interface element to initiate the purchase of a product (e.g. add it to a cart). User Device 103 may track and/or transmit information associated with a transaction to Advertising Evaluation System 101 and/or Advertising Channels and Publishers 107. In some embodiments, this information is transmitted as part of the user interaction information.

User Device 103 may include one or more computer systems, including at least one processor (such as an x86 or x64 compatible processor) and at least one memory storage device (such as flash memory).

Referring to FIG. 2A, illustrating a table of tracking user interactions across advertising channels and/or publishers, consistent with the disclosed embodiments. As described above, one or more systems may track user interactions (e.g. including, tracked clicks, impressions, transaction information) with one or more advertising channels and/or publishers. For example, the information shown in FIG. 2A may be stored in Incrementality System 104 for tracking user interactions. As described above, the one or more systems may track the user interactions for a window of time leading up a transaction (e.g. purchase, add to cart). The tracked user interaction information may include a user identifier 206 associated with the user. Therefore, user interactions by the same user across multiple user devices can be associated with the same user. The tracked user interaction information may include a time of the interaction 201. For example, the system may record a time of a click on an advertisement or impression of an advertisement. The time may include a date and time of day and/or a time in relation to an end transaction 106 (e.g. 1.5 hr before transaction). For example, leading up to the transaction, the user interacted with advertisements at 10:00 am, 1:20 pm, 1:21 pm, and 4:10 pm. Further, the one or more systems may record the time of visiting a company website, even if there is no interaction with advertising. For example, the user interacted with the company website at 4:00 pm.

Further, the one or more systems may associate each user interaction with a Channel 202 where that interaction took place. For example, the one or more systems may associate a first interaction with a first channel identifier, Ch 1, and the one or more systems may associate a second interaction with a second channel identifier, Ch 2. As described above, a company may decide to track multiple publishers together and assign them the same channel identifier. Further, the one or more systems may associate each user interaction with a Publisher 203 where that interaction took place. For example, a first interaction may be associated with a first publisher of a first channel, C1 Pub1, and a second interaction may be associated with a third publisher of second channel, C2 Pub3. In some embodiments (as shown), the publisher identifiers may identify the channel that the publisher is publishing within, while in other embodiments the publisher identifier may not reference any channel.

Further, the one or more systems may associate each user interaction with a Campaign Tag 204. Company Device 102 may create the Campaign Tag 204 to track an advertisement (e.g. a communication), thereby creating a tracked electronic advertisement (e.g. a tracked communication). In some embodiments, the Campaign Tag 204 may indicate information about the advertisement that the user interacted with. The Campaign Tag 204 may indicate information about the content displayed in the advertisement, such as an information on an image used in the advertisement, information on a product type advertised, information on the type of product description, information on the price description, and/or information on the sale description. The campaign tag may indicate information about the type of user being targeted, such as an age range of users being targeted and/or a gender of users being targeted. In some embodiments, Company device 102 may assign identifiers for Channel 202, Publisher 203, and Campaign Tag 204. In some embodiments, one or more platforms may assign the identifiers and a company system (e.g. Advertising Evaluation System 101) may execute instructions to convert the identifiers into a common channel or publisher identifier used across platforms.

Further, the one or more systems may identify each user interaction as an organic interaction or a non-organic interaction 205. In some embodiments, a non-organic interaction is an interaction with an advertisement and/or an interaction that results from an interaction with an advertisement. In some embodiments, an organic interaction is an interaction with a company webpage that did not result from interacting with an advertisement. For example, the one or more systems may label each of the user interactions with advertisements at 10:00 am, 1:20 pm, 1:21 pm, and 4:10 μm to indicate they are non-organic interactions. Further, as shown, the one or more systems may label the user interaction(s) on the company website 121 at 4:00 pm to indicate it is an organic interaction. In some embodiments, organic v. non-organic interactions may not be identified separately. Instead, the one or more systems may determine an action to be organic or non-organic based on a different identifier (e.g. a channel identifier).

Further, the one or more systems may group each user interaction into a category for weighting based on the time of the user interaction leading up to a transaction. In some embodiments, user interactions may be placed in categories for weighting based on the time they occurred leading up to a purchase. For example, in some embodiments, the one or more systems may categorize user interactions into two, three, four, or more buckets based on the time of the user interaction. In some embodiments, each bucket may include the same time window, while in other embodiments each bucket may include differing time windows. For example, the user interaction at 10:00 am is categorized in a first time window, the user interactions at 1:20 pm and 1:21 pm are categorized in a second time window, the user interactions at 4:00 pm and 4:10 pm are categorized in a third time window. As described above, user interactions closer to the transaction may be weighted more heavily.

Further, the one or more systems may associate each user interaction with a User Device 211 (e.g., User Device 103) on which each user interaction is performed. The one or more systems may receive a user device identifier identifying the device on which an interaction was received and may label the interaction accordingly. For example, a user may have a first phone, a second phone, a tablet, a laptop, and a PC, and each device may be associated with its own identifier. For example, the one or more systems may label the user interaction at 10:00 am to indicate it was on a second user device, device 2. The one or more systems may label each of the user interactions at 1:20 pm, 1:21 pm, 4:00 pm and 4:10 pm to indicate they were on a first user device, device 1. In some embodiments, tracking the user device may additionally or alternatively include tracking how a user accessed the electronic advertisement or webpage on the device. For example, the one or more systems may track whether the user interaction was on a browser or an application of a user device (e.g., label the interaction Device 1_Browser or Device 1_App).

Further, user interactions may include transaction information 207 received from one or more systems, as described above. For example, transaction information 207 may include one or more of a type of transaction (e.g. a purchase, adding to cart etc.), a product identifier, a total value of the products, and a quantity of products. For example, the type of transaction may be a purchase, the product identifier may be a number and/or text description of a sweater, the total value of the sweater may be $15, and the quantity may be one. The user interactions may include one or more of: only clicks, only impressions, or a combination of clicks and impressions. While the table shown in FIG. 2a shows one way of associating user interaction data, the data can be associated in many different formats. User interaction data can be stored in any format that allows for linking the user interactions with one or more of: time, channel ID, publisher ID, campaign tag, device identifier, and transaction information.

Referring to FIG. 2B, illustrating a table of weighting user interactions across advertising channels and/or publishers based on proximity to a transaction, consistent with the disclosed embodiments. As described above, one or more systems may track user interactions with one or more advertising channels and/or publishers. For example, the information shown in FIG. 2B may be stored in Incrementality System 104 for tracking user interactions. In some embodiments, all the user interactions within a category 208 may equal a set value that is even across all categories. The set value may be apportioned evenly based on the user interactions on a channel and/or publisher that take place in each category 208. As shown in FIG. 2B, two user interactions occur in middle category on a first and second channel so the interactions are apportioned evenly between a first channel, Ch 1, and a second channel, Ch 2. The set value is 1, so each Channel receives .5 of the set value of 1. However, the set value could be any value and each channel would receive half of the set value. As another example (not shown), within a category, a user may interact with a first channel once, a second channel twice, and a third channel once. If the set value is one, the value would be apportioned so that the first channel Ch 1 receives .25, the second channel Ch 2 receives .5, and the third channel Ch 3 receives .25.

Further, the one or more systems may apportion the user interactions with publishers. As shown in FIG. 2B, two user interactions occur in middle category on a third publisher of a first channel C1 Pub3 and a third publisher of a second channel C2 Pub 3, so the interactions are apportioned evenly between the third publisher of a first channel C1 Pub3 and the third publisher of a second channel C2 Pub 3. The set value is 1, so each publisher receives .5 of the set value of 1. However, the set value could be any value and each publisher would receive half of the set value. Further, the one or more systems may apportion the user interactions with advertising campaigns. As shown in FIG. 2B, two user interactions occur in a middle category associated with a first campaign tag 1 and a second campaign tag 2, so the interactions are apportioned evenly between the first campaign tag 1 and the second campaign tag 2.

Further, in some embodiments, the one or more systems may weight each apportioned value. The one or more systems may assign each category a weight 209 and the one or more systems may multiply the apportioned value by the weight. In some embodiments, each apportioned value associated with a channel, publisher, and/or campaign tag will be weighted and summed together. In some embodiments, the one or more systems may weight categories of user interactions closer to a transaction more heavily than user interactions that are further from the transaction. For example, as shown in FIG. 2B, the first category is assigned a weight of 0.13, the second category is assigned a weight of 0.27, and a third category is assigned a weight of 0.6. Therefore, summing the weighted apportion values for each channel returns a value of 0.265 associated with Channel 1, Ch 1, a value of 0.135 associated with Channel 2, Ch 2, and a value of 0.6 associated with Channel 3, Ch 3. Similarly, summing the weighted apportion value for each publisher returns a value of 0.13 associated with Channel 1 Publisher 1, a value of 0.135 associated with Channel 1 Publisher 3, a value of .135 associated with Channel 2 Publisher 3, and a value of 0.6 associated with Channel 3 Publisher 1. Similarly, summing the weighted apportioned value for each campaign tag returns a value of 0.865 for campaign tag 1 and .135 for campaign tag 2.

While the above description describes a process that splits user interactions into categories and apportions them to sum to a set value within each category, the invention is not so limited. In some embodiments, the user interactions are not apportioned within a category and/or are not weighted. In some embodiments, each user interaction may have an identical value and the weight given to the user interaction may vary based on the time or order of the interaction in relation to a user transaction (e.g., closer in time to a user transaction may receive a higher weight) without categories.

Referring to FIG. 3, illustrating a flow chart for apportioning a transaction, consistent with the disclosed embodiments. In some embodiments, the process of FIG. 3 is performed by Incrementality System 104, while in other embodiments one or more steps of the process in FIG. 3 may be executed by De-targeting System 105 and/or another device (including, e.g., Advertising Channels and Publishers 107, User Device 103, and/or Company Device 102).

At Step 301, the system aggregates user characteristic information and/or user interactions, as described above. For example, the system stores user characteristic information and/or user interactions from a plurality of users. User interaction information may include transaction information (e.g. purchases made, products added to cart etc.).

At Step 303, the system may determine which characteristics from the aggregated user characteristic information are relevant. For example, the system may determine a number of relevant characteristics.

A company, through Company Device 102, may set the number of relevant characteristics and/or the one or more systems may determine the number of relevant characteristics based on how many characteristics meet a threshold level of impact on a user's probability of completing a transaction. For example, determining relevant characteristics may include selecting user characteristics whose value makes a transaction more or less likely. For example, determining relevant characteristics may include selecting user characteristics whose value impacts the probability of a user completing a transaction by a set threshold (e.g. 2%, 5%, 10%, 15%, 20%). In some embodiments, relevant user characteristics are set by the company (e.g. on Company Device 102). In some embodiments, relevant user characteristics may include one or more of: a membership status in a company program, a purchasing status of the user, a recency, frequency, monetary value (RFM) status of the user, an age of the user, or a gender of the user.

After determining the relevant characteristics, the system may determine the weight of each characteristic. In some embodiments, the system may determine the weights assigned to each characteristic using a linear regression model. A linear regression model is a statistical model that estimates the linear relationship between a response and one or more variables. For example, a linear regression model may include:

$$Y ( 1 , 0 ) - intercept + aa * characteristic 1 value + bb * characteristic 2 value + cc * characteristic 3 value$$

The system may determine the weights of aa, bb, and cc by solving the linear regression model using the user characteristic information and user interaction information aggregated in Step 301. In some embodiments, user characteristic weights are the same across all users.

At Step 311, the system may aggregate user characteristic information and user interaction information for a specific user. For example, the system may determine user characteristic values for the relevant characteristics determined in Step 303. For example, the system stores user characteristic information and/or user interactions for the user collected over time (e.g, over a time window). Further, in some embodiments, the system may aggregate information associated with the user's transactions (e.g. click data, impression data, transaction data etc.). In some embodiments, the user's interaction information may include the information shown in FIG. 2A-FIG. 2B. For example, user interaction information may include user interactions that are apportioned and/or weighted as shown by the values of FIG. 2B results column 210.

At Step 304, the system may determine allocation model weights for allocating a transaction. In some embodiments, the allocation model weights are for allocating a transaction to one or more channels and are determined using a linear regression model. For example, a linear regression model may include an equation such as:

$$Y ( 1 , 0 ) = intercept + a * channel 1 interac tion value + b * channel 2 interaction value + c * channel 3 interaction value + aa * characteristic 1 value + bb * characteristic 2 value + cc * characteristic 3 value + aaa * past channel 1 interaction value + bbb * past channel 2 interaction value + ccc * past channel 3 interaction value .$$

The system may determine the user interaction weight values a, b, and c for each user by solving the linear regression model based on the user's characteristic information and user's interaction information collected at Step 311 and characteristic model weights determined at Step 303.

In some embodiments, the user interaction values used in the linear regression model are the apportioned and/or weighted values from FIG. 2B. For example, channel 1 interaction value may be .265, channel 2 interaction value may be .135, and channel 3 interaction value may be .6. Further, the user interaction values inputted into the equation may exclude organic interactions. The user interaction weights for past interactions (e.g. aaa, bbb, ccc) may be past solutions to the linear regression model and/or may be set by a company (e.g. through Company Device 102). The system may track past interactions for a period of time set by a company (e.g. through Company Device 102). For example, in some embodiments, past interactions may be tracked for the last 30 days.

The system may base the allocation model weights (e.g. A,B,C) on user interaction weights (a,b,c) determined through solving the above linear regression model. In some embodiments, the allocation model may determine allocation weights as a percentage based on (a,b,c). For example, the relative difference between A, B, and C may match the relative difference between a, b, and c.

Similarly, in some embodiments, the allocation model weights are for allocating a transaction to one or more publishers and are determined using a linear regression model that accepts a user's interactions with one or more publishers. For example, a linear regression model may include an equation such as:

$$Y ( 1 , 0 ) = intercept + a * publisher 1 interaction value + b * publisher 2 interaction value + c * publisher 3 interaction value + d * publisher 4 interaction value + aa * characteristic 1 value + bb * characteristic 2 value + cc * characteristic 3 value + aaa * past publisher 1 interaction value + bbb * past publisher 2 interaction value + ccc * past publisher 3 interaction value + ddd * past publisher 4 interaction value .$$

As in determining allocation weights for one or more channels, in some embodiments, the user interaction values used in the publisher linear regression model are the apportioned and/or weighted values from FIG. 2B. For example, publisher 1 interaction value may be .13, publisher 2 interaction value may be .135, publisher 3 interaction value may be .135, and publisher 4 interaction value may be .6. The user interaction values and channels may exclude organic interactions. Past interactions may be determined in the same manner(s) as past interactions in the linear regression model for channel allocation. The system may base the allocation model weights for one or more publishers (e.g. A,B,C,D) on user interaction weights (a,b,c,d) determined through solving the linear regression model.

At Step 307, the system may receive new user interaction information. For example, in some embodiments, the user interaction information may include the information shown in FIG. 2A-FIG. 2B. For example, user interaction information may include user interactions that are apportioned and/or weighted as shown by the values of FIG. 2B results column 210. The user interaction information may further include information about a transaction. For example, in some embodiments, the transaction may be a purchase, and the transaction information may include a price for the purchase, a quantity of products included in the purchase, a revenue made by the purchase, and/or a profit made by the purchase. In some embodiments, the transaction may include adding products to a cart, and the transaction information may include a price of products in the cart and/or a quantity of products included in the cart. In some embodiments, the transaction may include entering payment information for products, and the transaction information may include a price of products who have payment information added and/or a quantity of products that have payment information added.

At Step 309, the system may allocate user transactions between one or more channels by weighting the transaction value by the allocation model weight. In some embodiments, the apportioned transaction value for a first channel may equal A * channel 1 new interaction value * transaction amount. In some embodiments, after apportioning the transaction to each channel, the system may assign a remaining value of the transaction as not attributable to advertising. In some embodiments, the apportioned transaction value for a first publisher may equal A * publisher 1 new interaction value * transaction amount. In some embodiments, after allocating the transaction to each publisher, the system may assign a remaining value of the transaction as not attributable to advertising. As described with respect to Step 307, the transaction amount may include a price, quantity of products, revenue, or profit. The allocation is more accurate than allocations by existing systems because it considers the impact of user interactions and user characteristics on each channel.

In other embodiments, the system may determine the allocation model weights (A,B,C) in Step 309. For example, the system may base an allocation model weight on the user interaction weights (a,b,c) from the linear regression model and the new interaction information. For example, a transaction amount that may be apportioned to channel 1 may include A*transaction amount.

At Step 311, the system may determine and/or update a return on electronic advertising spending for the user. In some embodiments, the system may determine an allocation amount for a transaction that is attributable to advertising across all channels and publishers and may update a return on advertising spending (ROAS) based on this total allocation amount. For example, a return on advertising spending may be calculated and/or updated using the below equation.

$$ROAS = \frac{\sum User transa ction amt . allocated to advertising}{\sum Relative cost of advertising to user}$$

In some embodiments, the system may determine an allocation amount for a transaction that is attributable to a single channel or publisher and may update a return on advertising spending (ROAS) based on this allocation amount. For example, a return on advertising spending for a specific channel may be calculated and/or updated using the below equation.

$$ROAS = \frac{\sum User transa ction amt . allocated to advertising on channel 1}{\sum Relative cost of advertising to user on channel 1}$$

In some embodiments, the system may determine an allocation amount for a transaction that is attributable to interactions on a user device. In some embodiments, the received interaction information at Step 307 may separately consider interactions made on different user devices and may determine a corresponding weight (e.g., A) for each advertising channel (and/or publisher) when the user is interacting with a certain user device. For example, a return on advertising spending for a certain user device may be calculated and/or updated using the below equation:

$$ROAS = \frac{\sum User transa ction amt . allocated to advertising on device 1}{\sum Relative cost of advertising to user on channel 1}$$

In some embodiments, the system may additionally or alternatively determine an incremental return on advertising spending (iROAS) based on comparing the transaction amount (e.g., without allocation) of a user to a control group of users who did not receive any advertising. In some embodiments, the system may reference one or more of the relevant user characteristics (e.g., as determined in Step 303) to establish a control group of users for comparison.

$$iROAS = \frac{\sum User transaction amt . - \sum Control group transaction amt .}{\sum Relative cost of advertising to user}$$

The process detailed above provides an example of using one or more linear regression models to determine the characteristic model weight at Step 303 and to determine the allocation model weight at Step 304, but the disclosure is not so limited. The system may use any type of model to determine the user characteristic model weight and/or the allocation model weight. In some embodiments the system may use a neural network to perform at least one of the above steps. The neural network may comprise an input layer, one or more hidden layers, and an output layer. For example, the system may use a neural network to determine the relevance and impact of one or more user characteristics. The neural network may receive user characteristic values for a plurality of users. As described above, user characteristics may include membership status in a company program, a purchasing status of the user, a recency, frequency, monetary value (RFM) status of the user, an age of the user, gender of the user, or any other user characteristic. Further, the neural network may receive information on transactions completed by the plurality of users (including, e.g. whether they completed a transaction in a set time period). In some embodiments, the neural network may include a number of nodes corresponding to the number of user characteristic types inputted. Based on processing the characteristic data and corresponding transaction information, the neural network may determine the weight each user characteristic has on a probability of completing a transaction.

Similarly, the system may use a neural network to determine the impact of user interaction on one or more channels or publishers. The neural network may receive the user interactions for a user. As described above, user interactions may include impressions and/or clicks on advertising posted in one or more channels and/or publishers as shown in FIG. 2a. Further, the neural network may receive information on transactions completed by a user (including, e.g. whether they completed a transaction in a time period). The neural network may include a number of nodes corresponding to the number of channels or publishers being tracked. Based on processing the user interaction data and corresponding transaction information, the neural network may determine the weight each user interaction on a channel or publisher has on a probability of completing a transaction. In some embodiments, the system may use a single neural network to evaluate both user characteristic information and user interactions.

Referring to FIG. 4, illustrating a flow chart for electronic advertising de-targeting, consistent with the disclosed embodiments. In some embodiments, the process of FIG. 4 is performed by De-targeting System 105, while in other embodiments one or more steps of the process in FIG. 4 may be executed by Incrementality System 104 and/or another device (including, e.g., Advertising Channels and Publishers 107, User Device 103, and/or Company Device 102).

At Step 401, the system may receive parameters for performing de-targeting evaluation. In some embodiments, the system may receive (e.g., from Company Device 102), one or more timeframe(s) for performing de-targeting. In some embodiments, Company Device 102 may specify that the de-targeting process is to be performed for a 10 day period, month, quarter, or any other period of time that the company determines is beneficial for de-targeting. In some embodiments, the system may receive (e.g., from Company Device 102) a time-frame for evaluating whether users had a positive, neutral, or negative impact to advertising, as detailed in Step 403 below. In some embodiments, the system may receive (e.g., from Company Device 102), one or more time intervals for performing re-targeting evaluation, as detailed in Step 411 below. For example, Company Device 102 may specify that re-targeting evaluation Step 411 is to be performed every week. In some embodiments, the system may receive (e.g., from Company Device 102) information on when to repeat the de-targeting process (e.g., repeatedly, after a set delay in time, and/or after new advertising is launched).

In some embodiments, the system may receive (e.g., from Company Device 102) one or more thresholds for performing the de-targeting process. For example, Company Device 102 may specify one or more thresholds for determining whether electronic advertising has a positive, neutral, or negative impact on a user, as detailed in Step 403 below, and/or one or more thresholds for determining whether test group users are experiencing a declining performance relative to the control group users, as detailed in Step 411 below.

In some embodiments, the system may receive (e.g., from Company Device 102) one or more of a number or proportion of users to be added to a control group and/or to a test group, as detailed in Step 407 below. In some embodiments, the system may receive (e.g., from Company Device 102) user characteristics, such as membership status in a company program, a purchasing status of the user, a recency, frequency, monetary value (RFM) status of the user, an age of the user, gender of the user, or any other user characteristic (e.g., relevant user characteristics gathered in FIG. 3, Step 311) to split the users into the control group and test group.

In some embodiments, the system may receive (e.g., from Company Device 102) an indication of a group of users who will be evaluated for de-targeting. For example, Company Device 102 may specify user identifiers for each user upon which the de-targeting process will be performed. In some embodiments, the system may receive (e.g., from Company Device 102) an indication of one or more advertising campaigns that are to be evaluated for de-targeting. For example, Company Device 102 may specify an advertising campaign identifier (e.g., Campaign Tag 204), and the system will perform the de-targeting process for users with respect to the identified advertising campaign. In some embodiments, the system may receive (e.g., from Company Device 102) one or more channels and/or publishers that are to be evaluated for de-targeting. For example, Company Device 102 may specify a channel identifier and/or a publisher identifier (e.g., Channel 202 and/or Publisher 203), and the system will perform the de-targeting process for users with respect to the identified publisher and/or channel. In some embodiments, the system may receive (e.g., from Company Device 102) on or more user device(s) that are to be evaluated for de-targeting. For example, Company Device 102 may specify one or more user device identifiers (e.g., User Device 211), and the system will perform the de-targeting process for users with respect to the identified one or more user devices.

In some embodiments, the system may receive (e.g., from Company Device 102) a combination of identifiers for performing the de-targeting process. For example, Company Device 102 may specify a group of users (e.g., user identifiers) and an advertising campaign (e.g., an advertising campaign identifier) to perform the de-targeting process. Therefore, users that are determined to have a negative reaction to the campaign's advertisement(s) whose purchasing tendencies does not decline (e.g., step 411, below) upon being removed from the campaign's advertisements, can be prevented from seeing the campaign's advertisements while still receiving advertisements from other campaigns. For example, Company Device 102 may specify a user device to perform the de-targeting process. Therefore, a user who is determined to have a negative reaction to advertisements when interacting on a certain device whose purchasing tendencies do not decline upon being removed from seeing advertisements on the device, can be prevented from seeing advertisements on the device while still receiving advertisements on other devices.

While the above are provided as an example of different identifiers that the system may use to perform de-targeting process, the system may perform de-targeting in consideration of any combination of the identifiers (e.g., identified users, advertising campaigns, channels, publishers, and/or user devices).

At Step 403, the system may determine users' responses to advertising over a set timeframe by comparing a purchasing metric to a threshold. In some embodiments, the system may receive information on and/or track user interactions and transactions over the set timeframe and determine which users have a positive response to advertising and which users have a neutral and/or negative response to advertising. In some embodiments, the timeframe and/or comparison threshold may be set through the Company Device 102, as described above.

In some embodiments, the system may receive information and/or track user interactions and transactions in consideration of the identifiers established in Step 401 (e.g., identified users, advertising campaigns, channels, publishers, and/or user devices). In some embodiments, the system may track user interaction information (e.g., as shown in FIG. 2A) in consideration of the identifiers established in Step 401. For example, the system may gather only relevant interaction data and/or filter stored interaction data (e.g., interaction data of FIG. 2A) using the identifiers established in Step 401.

In some embodiments, the system (e.g., De-targeting System 105) may instruct Incrementality System 104 (and/or may itself perform one or more steps of the FIG. 3 process) to apportion user transactions based on the relevant interaction data. For example, De-targeting System 105 and/or Incrementality System 104 may perform the process of FIG. 3 to determine, for each user, a transaction amount allocated to one or more of: identified advertising campaign(s), channel(s), publisher(s), and/or user device(s), as described above with respect to FIG. 3 Step 309.

In some embodiments, the system (e.g., De-targeting System 105) may instruct Incrementality System 104 (and/or may itself perform one or more steps of the FIG. 3 process) to determine, for each user, a ROAS or iROAS value, as described above with respect to FIG. 3 Step 311. In some embodiments, the system may determine that a user has a positive response to advertising when the ROAS and/or iROAS value is above a set threshold (e.g., received via Company Device 102 in Step 401), and may determine that the user has a negative or neutral reaction to advertising when the ROAS and/or iROAS value is below the set threshold.

In some embodiments, the system may implement a process other than that described in FIG. 3 to determine the ROAS or iROAS value. In some embodiments, an iROAS value is determined based on an incremental revenue generated by advertisements. In some embodiments, the incremental revenue may be an amount spent by a user when they receive advertisements minus the amount spent by the user when they don't receive advertisements. In some embodiments, the incremental revenue may be an amount spent by a user when they receive advertisements minus an amount spent by a control group that does not receive advertisements. For example, an amount spent by a user within a threshold time of interacting with electronic advertisements (e.g., clicking on them) may be compared to an amount spent by a user or control group without interacting with electronic advertisements in the threshold time. In some embodiments, the incremental revenue is divided by an amount spent on the advertisements (e.g., an amount spent on the user). In some embodiments, the system may determine that a user has a positive response to advertising when the iROAS value is positive and/or meets a set threshold (e.g., received via Company Device 102 in Step 401) and may determine that the user has a negative or neutral reaction to advertising when the iROAS value is negative, zero, and/or does not meet a set threshold.

In some embodiments, determining an iROAS or ROAS value as described above may more accurately reflect a user's reaction to advertising than other methods. Users with a negative or neutral reaction to advertising can be accurately identified and removed from receiving electronic advertisement (e.g., added to control group at step 413, described below) without incidentally removing users who actually have a positive reaction to advertising. Therefore, overall consumer spending (e.g., as reflected in a GMV) may remain roughly constant, while significant advertising costs are saved through the user removal.

In some embodiments, the system may perform different process(es) to determine a user response to advertising. In some embodiments, the system may determine that a user has a positive response to advertising when more purchases are made over the set timeframe after interacting with advertising than without interacting with advertising and may otherwise determine the user has a negative or neutral response to advertising. For example, a number of purchases made within a threshold time of interacting with electronic advertisements (e.g., clicking on them) may be compared to a number of purchases made without interacting with electronic advertisements in the threshold time.

In some embodiments, the system may determine that a user has a positive response to advertising when they make a number of purchases over a set threshold (e.g., received via Company Device 102 in Step 401) after interacting with advertising, and may otherwise determine the user has a negative or neutral response to advertising. For example, a number of purchases made within a threshold time of interacting with electronic advertisements (e.g., clicking on them) may be compared to a threshold number of purchases.

In some embodiments, the system may determine that a user has a positive response to advertising when they spend an amount over a set threshold (e.g., received via Company Device 102 in Step 401) after interacting with advertising, and may otherwise determine the user has a negative or neutral response to advertising. For example, an amount spent within a threshold time of interacting with electronic advertisements (e.g., clicking on them) may be compared to a threshold.

At Step 405, users who have a positive response to advertising will continue to receive advertisements. For example, the system may generate instructions to store them (e.g., corresponding user identifiers) in a group of users to receive advertisements, may update an advertisement indicator on a table (e.g., a searchable table) to indicate the users are to receive advertising, and/or may communicate to another system (e.g., Company Device 102) that the users are to receive advertising. In some embodiments, when the de-targeting process is performed in consideration of certain identifiers (e.g., advertising campaigns, channels, publishers, and/or user devices received in Step 401), the storing, updates, and communications may also indicate which identifiers the instruction to provide advertising corresponds to.

For example, the system may filter a searchable table based on the identifier(s) and may only update an advertisement indicator corresponding to the identifier(s) (e.g., indicator may indicate user is to receive advertisements from a set campaign being evaluated in the de-targeting process). For example, the system may communicate to another system indicating “User 1 should continue to receive all advertisements on user device 1”.

In some embodiments, the system (and/or Company Device 102) may automatically enable users with a positive response to advertising to receive advertisements. In some embodiments, the system (and/or Company Device 102) may provide a notice so that a user of a company can manually enable users with a positive response to advertising to receive advertisements (e.g., via Company Device 102).

At Step 407, the system may split users who have a negative or neutral response to advertising into a test group and a control group. In some embodiments, the proportion and/or number of users to be included in the test group and control group may be set by Company Device 102. For example, a user on Company Device 102 may set a percentage, fraction, or quantity of users to be in the test group and the control group. In some embodiments, a larger portion of users will be included in the test group than the control group. For example, in some embodiments, the system may include 70-95% of users in the test group and the rest will be in the control group.

In some embodiments, the system may randomly assign users into the test group and control group. For example, the system may randomly select user identifiers to assign to each group. In some embodiments, the system may assign users into the test group or control group in consideration of user characteristics (e.g., relevant characteristics determined in FIG. 3 Step 303) to have relative consistency in purchasing tendencies between the groups. For example, the system may split users (e.g., user identifiers) into the test group and control group such that each group's average impact of user characteristics on purchasing behavior (e.g., sum of weight given to user characteristics, as detailed in Step 303 above) is within a threshold of the other.

In some embodiments, the system may use a machine learning model to correct for bias in selecting between the test group and the control group. For example, the system may train a machine learning model to determine the relevance and impact of user characteristics on a tendency to be exposed to advertising. The system may provide the machine learning model with user characteristics, such as membership status in a company program, a purchasing status of the user, a recency, frequency, monetary value (RFM) status of the user, an age of the user, gender of the user, or any other user characteristic. The system may also provide the machine learning model with information related to advertisement exposure, such as click data, impression date, selection data, and/or any other data related to users being exposed to advertising. Based on the inputted data, the machine learning model may be trained to establish an impact each user characteristic has on a tendency to be exposed to advertising.

Therefore, upon receiving a new group to divide into a test group and control group, the system may determine a likelihood of exposure of each user to advertising (e.g., an exposure bias value) and may apportion the users between the test group and control group so that each group's likelihood of exposure to advertising (e.g., an average value of likelihood to exposure to advertising) is roughly equal (e.g., within a threshold amount and/or as close as possible).

At Step 413, the users in the control group will continue to receive advertisements. For example, as described above with reference to Step 405, the system may generate instructions to store them (e.g., corresponding user identifiers) in a group of users to receive advertisements, may update an advertisement indicator on a table (e.g., a searchable table) to indicate the users are to receive advertising, and/or may communicate to another system (e.g., Company Device) that the users are to receive advertising. In some embodiments, when the de-targeting process is performed in consideration of certain identifiers (e.g., advertising campaigns, channels, publishers, and/or user devices received in Step 401), the storing, updates, and communications may also indicate which identifiers the instruction to provide advertising corresponds to.

For example, the system may filter a searchable table based on the identifier(s) and may only update an advertisement indicator corresponding to the identifier(s) (e.g., indicator may indicate user is to receive advertisements from a set campaign being evaluated in the de-targeting process).

In some embodiments, the system (and/or Company Device 102) may automatically enable the control group users to receive advertisements. In some embodiments, the system (and/or Company Device 102) may provide a notice so that a user of a company can manually enable the control group users to receive advertisements (e.g., via Company Device 102).

Further, in some embodiments, the system may store the users (e.g., corresponding user identifiers) in a group of users whose purchases and interactions will continue to be tracked, may update a tracking indicator on a table (e.g., a searchable table) to indicate the users will continue being tracked, and/or may communicate to another system (e.g., Company Device and/or one or more systems of Advertising Channels and Publishers 107) that the users will continue to be tracked.

At Step 409, the users in the test group will stop receiving advertisements. For example, the system may generate instructions to store them (e.g., corresponding user identifiers) in a group of users to not receive advertisements, may update an advertisement indicator on a table (e.g., a searchable table) to indicate the users are not to receive advertising, and/or may communicate to another system (e.g., Company Device) that the users are not to receive advertising. In some embodiments, when the de-targeting process is performed in consideration of certain identifiers (e.g., advertising campaigns, channels, publishers, and/or user devices received in Step 401), the storing, updates, and communications may also indicate which identifiers the instruction to not provide advertising corresponds to.

For example, the system may filter a searchable table based on the identifier(s) and may only update an advertisement indicator corresponding to the identifier(s) (e.g., indicator may indicate user is not to receive advertisements from a set campaign being evaluated in the de-targeting process). For example, the system may communicate to another system indicating “User 2 should not receive any advertisements on user device 1”.

In some embodiments, when the de-targeting process is performed for a specific advertisement or group of advertisements (e.g., corresponding to an advertising campaign identifier), the system may generate instructions for the removed advertisement or group of advertisements to be replaced with another advertisement or group of advertisements (e.g., corresponding to a different campaign identifier). In some embodiments, the system may evaluate a user's response to another advertisement or group of advertisements (e.g., iROAS, ROAS, or other response metric as described above with respect to step 403) and generate instructions to provide the advertisement or group of advertisements with the most positive response (e.g., highest iROAS value) and/or a response metric over a threshold. For example, a user with a negative response to food advertisements may have those advertisements replaced with fashion advertisements for which they have demonstrated a positive response.

In some embodiments, the system (and/or Company Device 102) may automatically disable the test group users from receiving advertisements. In some embodiments, the system (and/or Company Device 102) may provide a notice so that a user of a company can manually disable test group users from receiving advertisements (e.g., via Company Device 102).

Further, in some embodiments, the system may store the users (e.g., corresponding user identifiers) in a group of users whose purchases and interactions will continue to be tracked, may update a tracking indicator on a table (e.g., a searchable table) to indicate the users will continue being tracked, and/or may communicate to another system (e.g., Company Device and/or one or more systems of Advertising Channels and Publishers 107) that the users will continue to be tracked.

At Step 411, the system may compare the purchasing behavior of the test group users (e.g., Step 409) to the control group users (e.g., Step 413). In some embodiments, this comparison is performed at a set time interval (e.g., a time interval provided by Company Device 102 in Step 401). Following the comparison, users with declining purchase behavior relative to the control group may be re-added to receive advertisements (e.g., user identifiers may be re-assigned to control group).

In some embodiments, this comparison is performed at a first time interval (e.g., a few hours or a day) and if a test group user's purchasing performance declines below a first threshold relative to the control group (e.g., over a threshold in the range of 20-50%), the user may be re-added to receive advertisements. In some embodiments, this comparison is also performed repeatedly at a second time interval (e.g., a time interval larger than the first, such as a few days or a week), and if a test group user's purchasing performance declines below a second threshold (e.g., a threshold smaller than the first threshold, such as any decline, any decline over a standard deviation, and/or any decline over 5%) relative to the control group then the user may be re-added to receive advertisements.

In some embodiments, purchasing behavior may be measured based on a number of purchases, value of purchases, profit margin of purchases, transaction amount allocated to advertising, iROAS, ROAS, or other metrics. In some embodiments, system may determine the purchasing behavior for each user by performing (and/or directed another system to perform) one or more steps of FIG. 3.

In some embodiments, if the test group user's purchasing behavior declines relative to the control group (e.g., is less than an average purchasing behavior of the control group), the user will be re-added to the control group (e.g., Step 413). In some embodiments, a fluctuation in purchasing behavior is considered in determining whether a test group user's purchasing behavior has declined relative to the control group. For example, the system may determine a standard deviation of the control group's purchasing behavior and may determine that the user's purchasing behavior relative to the control group has decline when the user's purchasing behavior is less than a lower standard deviation of the control group's purchasing behavior (e.g., spending or number of purchases).

In some embodiments, the system may also determine and consider a standard deviation of the test group user's purchasing behavior to determine whether the user's purchasing behavior has declined relative to the control group. For example, the system may determine that the test user's purchasing behavior relative to the control group has decline when the user's purchasing behavior is less than a lower combined standard deviation of the user and the control group (e.g., a sum of standard deviations, average of standard deviations etc.).

In some embodiments, the purchasing behavior of each user in the test group will be compared to a purchasing behavior of a group of one or more users in the control group with similar user characteristics. For example, a test group user may be compared to user(s) in the control group with one or more overlapping user characteristics, such as membership status in a company rewards program, RFM status (i.e. recency, frequency and monetary total of their recent transactions), age, gender, and/or location. In some embodiments, the user characteristics that form the basis of comparison are identified by the system using one or more steps of FIG. 3.

In some embodiments, the process of FIG. 4 may be repeated for new users added for evaluation (e.g., via Company Device 102). For example, a new user's response to advertising may be evaluated (e.g., at Step 403). If the response to advertising is positive, the system may generate instructions for the user to receive advertising. If the response to advertising is negative or neutral, the system may generate instructions to add them to an existing test group or an existing control group. In some embodiments, new users with negative or neutral responses to advertising are automatically added to the test group and do not receive advertisements. Further, in some embodiments, a company may trigger the process of FIG. 4 to repeat for all users being evaluated (e.g., all users identified by Company Device 102 at Step 401). For example, a company (e.g. via Company Device 102) may set this process to repeat after making changes to advertising (e.g. content, platform etc.) so that users with a negative response to the changed advertising can be removed from receiving advertisements.

As described above, during the de-targeting process, the system may provide one or more metrics of the de-targeting process to be displayed to a user. For example, the system may provide one or more metrics to Company Device 102. As described above, in some embodiments, the metrics may include user identifiers, numbers of users, and/or proportions of users in each group (e.g., Sep 405, 413, and/or 419). In some embodiments, the metrics may include financial metrics, such as an overall gross merchandise value (GMV), profit, revenue, IROAS, ROAS, and/or advertising costs so that a user may track any changes in the de-targeting process. For example, a user of the company may track advertising savings while noticing that the GMV remains constant during the de-targeting process. In some embodiments, the metrics may track technical resources, such as available storage, processing resources, and/or network transmission resources. For example, a user of the company may track an increase in available technical resources during the de-targeting process. The metrics may be provided continuously, on a set interval (e.g., established by Company Device 102), and/or upon different steps being performed (e.g., Steps 405, 409, 411, and/or 413).

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A computer-implemented system for targeting electronic communications, the system comprising:
a memory storing instructions; and
at least one processor configured to execute the instructions to:
determine a response to electronic communications for each user of a group of users, by:
receiving interaction data indicating interactions with a first set of electronic communications via a first user device, associated with the user, in a first set period of time;
receiving purchase data indicating the user's purchases in the first set period of time;
determining a metric representing the user's response to the first set of electronic communications based on the received interaction data and the received purchase data; and
comparing the metric to a threshold to determine a response associated with the user regarding electronic communications;
generate first instructions for users with a determined positive response to electronic communications to receive electronic communications;
generate second instructions for a test group of users with a determined negative response to not receive electronic communications;
generate third instructions for a control group of users with a determined negative response to receive electronic communications;
send electronic communications by executing the first and third instructions; and
repeatedly re-assign user identifiers associated with the users in the test group to the control group after each increment of a second set period of time, by:
comparing purchasing behavior of each user in the test group to a purchasing behavior of the control group; and
removing user identifiers of users in the test group and assigning them to the control group to receive electronic communications when the comparison indicates the user's purchasing behavior has declined relative to the purchasing behavior of the control group.

2. The system of claim 1, wherein the at least one processor is further configured to:
receive from a second user device at least one of the first set period of time, the second set period of time, a proportion of users to be in the test group, a proportion of users to be in the control group, a number of users to be in the test group, a number of users to be in the control group, or the threshold to determine the response to electronic communications.

3. The system of claim 1, wherein the interaction data comprises at least one of:
clicks on the first set of electronic communications, swipes on the first set of electronic communications, impressions on the first set of electronic communications, or mouse hovering over the first set of electronic communications.

4. The system of claim 1, wherein the metric comprises at least one of:
a number of purchases made by the user following an interaction by the user with the first set of electronic communications;
an amount spent by the user following an interaction by the user with the first set of electronic communications;
an incremental return on advertising spending associated with the user during the first set period of time;
a user spending amount allocated to the first set of electronic communications determined using a model that adjusts the allocated spending amount in consideration of a time of an interaction by the user or a characteristic of the user.

5. The system of claim 1,
wherein determining a response to electronic communications for each user of a group of users further comprises:
receiving data from the user device indicating at least one characteristic of the user;
utilizing a model to correlate a purchasing tendency with the at least one characteristic and the received interaction data, wherein the model comprises at least one of a linear regression model or neural network; and
determining the metric representing the user's response to the first set of electronic communications based on an output of the model; and
wherein generating the first instructions for users with the determined positive response, generating the second instructions for the test group of users, and generating the third instructions for the control group of users is based on the comparing the metric to the threshold.

6. The system of claim 1, wherein the at least one processor is further configured to:
link the interaction data to at least one of an advertising campaign identifier, advertising channel identifier, or user device identifier,
wherein the determined metric corresponds to the at least one identifier.

7. The system of claim 1, wherein the test group includes more users than the control group.

8. The system of claim 1, wherein the at least one processor is further configured to:
determine at least one characteristic of the users in the test group and control group, comprising at least one of:
a membership status in a company program,
a purchasing status of the user,
a recency, frequency, monetary value (RFM) status of the user,
an age of the user, or
a gender of the user; and
wherein comparing purchasing behavior of each user in the test group to purchasing behavior of the control group comprises:
for each user in the test group, comparing the user to a subset of users in the control group based on a similarity in the at least one characteristic.

9. The system of claim 1, wherein the at least one processor is further configured to:
determine the user's purchasing behavior has declined relative to the purchasing behavior of the control group based on at least one of:
the user's spending being less than an average spending of the control group,
the user's spending being less than a lower standard deviation of the control group's spending,
the user's number of purchases being less than an average number of purchases of the control group, or
the user's number of purchases being less than a lower standard deviation of the control group's number of purchases.

10. The system of claim 1, wherein re-assigning user identifiers associated with the users in the test group to the control group comprises at least one of:
saving the user identifiers of the removed users to a list of users to receive electronic communications,
updating, for each user identifier of the removed users, an indicator in a table to indicate the user is to receive electronic communications, or
sending a notice to a device to indicate the users are to receive electronic communications.

11. A computer-implemented method for targeting electronic communications, the method comprising:
determining a response to electronic communications for each user of a group of users, by:
receiving interaction data indicating interactions with a first set of electronic communications via a first user device, associated with the user, in a first set period of time;
receiving purchase data indicating the user's purchases in the first set period of time;
determining a metric representing the user's response to the first set of electronic communications based on the received interaction data and the received purchase data; and
comparing the metric to a threshold to determine a response associated with the user regarding electronic communications;
generating first instructions for users with a determined positive response to electronic communications to receive electronic communications;
generating second instructions for a test group of users with a determined negative response to not receive electronic communications;
generating third instructions for a control group of users with a determined negative response to receive electronic communications;
sending electronic communications by executing the first and third instructions; and
repeatedly re-assigning user identifiers associated with the users in the test group to the control group after each increment of a second set period of time, by:
comparing purchasing behavior of each user in the test group to a purchasing behavior of the control group; and
removing user identifiers of users in the test group and assigning them to the control group to receive electronic communications when the comparison indicates the user's purchasing behavior has declined relative to the purchasing behavior of the control group.

12. The method of claim 11, further comprising:
receiving from a second user device at least one of the first set period of time, the second set period of time, a proportion of users to be in the test group, a proportion of users to be in the control group, a number of users to be in the test group, a number of users to be in the control group, or the threshold to determine the response to electronic communications.

13. The method of claim 11, wherein the interaction data comprises at least one of:
clicks on the first set of electronic communications, swipes on the first set of electronic communications, impressions on the first set of electronic communications, or mouse hovering over the first set of electronic communications.

14. The method of claim 11, wherein the metric comprises at least one of:
a number of purchases made by the user following an interaction by the user with the first set of electronic communications;
an amount spent by the user following an interaction by the user with the first set of electronic communications;
an incremental return on advertising spending associated with the user during the first set period of time;
a user spending amount allocated to the first set of electronic communications determined using a model that adjusts the allocated spending amount in consideration of a time of an interaction by the user or a characteristic of the user.

15. The method of claim 11,
wherein determining a response to electronic communications for each user of a group of users further comprises:
receiving data from the user device indicating at least one characteristic of the user;
utilizing a model to correlate a purchasing tendency with the at least one characteristic and the received interaction data, wherein the model comprises at least one of a linear regression model or neural network; and
determining the metric representing the user's response to the first set of electronic communications based on an output of the model; and
wherein generating the first instructions for users with the determined positive response, generating the second instructions for the test group of users, and generating the third instructions for the control group of users is based on the comparing the metric to the threshold.

16. The method of claim 11, further comprising:
linking the interaction data to at least one of an advertising campaign identifier, advertising channel identifier, or user device identifier,
wherein the determined metric corresponds to the at least one identifier.

17. The method of claim 11, wherein the test group includes more users than the control group.

18. The method of claim 11, further comprising:
determining at least one characteristic of the users in the test group and control group, comprising at least one of:
a membership status in a company program,
a purchasing status of the user,
a recency, frequency, monetary value (RFM) status of the user,
an age of the user, or
a gender of the user; and
wherein comparing purchasing behavior of each user in the test group to purchasing behavior of the control group comprises:
for each user in the test group, comparing the user to a subset of users in the control group based on a similarity in the at least one characteristic.

19. The method of claim 11, further comprising:
determining the user's purchasing behavior has declined relative to the purchasing behavior of the control group based on at least one of:
the user's spending being less than an average spending of the control group,
the user's spending being less than a lower standard deviation of the control group's spending,
the user's number of purchases being less than an average number of purchases of the control group, or
the user's number of purchases being less than a lower standard deviation of the control group's number of purchases.

20. A computer-implemented system for targeting electronic communications, the system comprising:
a memory storing instructions; and
at least one processor configured to execute the instructions to:
determine a response to electronic communications for each user of a group of users, by:
receiving click data indicating interactions with a first set of electronic communications via a first user device, associated with the user, in a first set period of time;
receiving data from the user device indicating at least one characteristic of the user;
utilizing a model to correlate a purchasing tendency with the at least one characteristic and the received interaction data, wherein the model comprises at least one of a linear regression model or neural network;
receiving a user purchase amount in the first set period of time;
determining a portion of the user purchase amount allocated the first set of electronic communications using the model; and
comparing the portion of user purchase amount allocated to the first set of electronic communications to a threshold to determine a response associated with the user regarding electronic communications;
generate first instructions for users with a determined positive response to electronic communications to receive electronic communications;
generate second instructions for a test group of users with a determined negative response to not receive electronic communications;
generate third instructions for a control group of users with a determined negative response to receive electronic communications;
send electronic communications by executing the first and third instructions; and
repeatedly re-assign user identifiers associated with the users in the test group to the control group after each increment of a second set period of time, by:
comparing purchasing behavior of each user in the test group to a purchasing behavior of the control group; and
removing user identifiers of users in the test group and assigning them to the control group to receive electronic communications when the comparison indicates the user's purchasing behavior has declined relative to the purchasing behavior of the control group.
